(19) United States
(12) Patent Application Publication
(10) Pub. No.: US 2025/0005909 A1
(43) Pub. Date: Jan. 2, 2025

(54) MODEL TRAINING APPARATUS, MODEL TRAINING METHOD, AND NON-TRANSITORY COMPUTER-READABLE STORAGE MEDIUM

(71) Applicant: NEC Corporation, Minato- ku, Tokyo (JP)

(72) Inventors: Jiro Abe, Tokyo (JP); Tatsuya Sumlya, Tokyo (JP); Kazumine Ogura, Tokyo (JP)

(73) Assignee: NEC Corporation, Minato- ku, Tokyo (JP)

(21) Appl. No.: 18/709,062

(22) PCT Filed: Mar. 16, 2022
(86) PCT No.: PCT/JP2022/012046

§ 371 Date: May 10, 2024

(51) Int. Cl. G06V 10/774; G06T 7/00; G06V 20/64

(52) U.S. Cl. CPC G06V 10/774; G06T 7/0002; G06V 20/64; G06T 2207/10028; G06T 2207/20021; G06T 2207/20081; G06T 2207/30184

(57) ABSTRACT

A model training apparatus (10) includes a first patch generation unit (110), a second patch generation unit (120), and a training unit (130). The first patch generation unit (110) generates, by using three-dimensional data indicating a shape of an object, at least one first patch being a subset of the three-dimensional data, and causes a first storage unit (20) to store the first patch. The second patch generation unit (120) reads out any of the first patches from the first storage unit (20), and generates at least one second patch being a subset of the first patch. The training unit (130) trains, with the second patch as training data, a model for evaluating a 10 three-dimensional shape. Then, the second patch generation unit (120) and the training unit (130) repeat processing until a criterion is satisfied.

### TECHNICAL FIELD

The present invention relates to a model training apparatus, a model training method, and a storage medium.

### BACKGROUND ART

Detecting an abnormality in an object by using three-dimensional data indicating a shape of the object has been considered. In recent years, detecting the abnormality by using a model trained by machine learning has been considered.

For example, Non-Patent Document 1 describes that a plurality of spherical patches being subsets are generated from three-dimensional data in such a way as to cover the entire three-dimensional data and the plurality of spherical patches are used as training data.

In a technique described in Non-Patent Document 1 described above, not all of the spherical patches that may be generated can be learned. Thus, performance of inference using a generated model is more dependent on patch segmentation in inference.

In contrast, Non-Patent Document 2 describes that three-dimensional data are read out at each epoch in training, and a spherical patch is randomly generated and input to a point cloud learner. The spherical patch is generated in such a way as to cover the entire three-dimensional data also in Non-Patent Document 2.

### RELATED DOCUMENTS

### Non-Patent Documents

Non-Patent Document 1: “Transforms,” in the API document of TorchPoints3D, [retrieved on Mar. 4, 2022] <URL:https://torch-points3d.readthedocs.io/en/latest/src/api/transforms.html>

Non-Patent Document 2: Thomas, et al., “KPConv: Flexible and deformable convolution for point clouds,” 2019, [retrieved on Feb. 28, 2022] <URL:https://arxiv.org/pdf/1904.08889.pdf>

### SUMMARY OF INVENTION

### Technical Problem

In the above-described Non-Patent Document 2, it is necessary to read out three-dimensional data indicating a shape of an object at each epoch during training. Thus, a load on an apparatus performing training is increased.

In view of the above-described problem, one example of an object of the present invention is to provide a model training apparatus, a model training method, and a storage medium that have a small load in training a model that evaluates three-dimensional data indicating a shape of an object.

### Solution to Problem

According to one aspect of the present invention, provided is a model training apparatus including:
a first patch generation unit that generates, by using three-dimensional data indicating a shape of an object, at least one first patch being a subset of the three-dimensional data, and causes a storage unit to store the first patch;
a second patch generation unit that reads out any of the first patches from the storage unit, and generates at least one second patch being a subset of the first patch; and
a training unit that trains, with the second patch as training data, a model for evaluating a three-dimensional shape, wherein
the second patch generation unit and the training unit repeat processing until a criterion is satisfied.

According to the present invention, provided is a model training method including,
by a computer:
generating, by using three-dimensional data indicating a shape of an object, at least one first patch being a subset of the three-dimensional data, and causing a storage unit to store the first patch;
reading out any of the first patches from the storage unit, and generating at least one second patch being a subset of the first patch; and
training, with the second patch as training data, a model for evaluating a three-dimensional shape, wherein
the generating the second patch and the training the model are repeated until a criterion is satisfied.

According to the present invention, provided is a computer-readable storage medium that stores a program causing a computer to have:
a first patch generation function of generating, by using three-dimensional data indicating a shape of an object, at least one first patch being a subset of the three-dimensional data, and causing a storage unit to store the first patch;
a second patch generation function of reading out any of the first patches from the storage unit, and generating at least one second patch being a subset of the first patch; and
a training function of training, with the second patch as training data, a model for evaluating a three-dimensional shape, wherein
the second patch generation function and the training function repeat processing until a criterion is satisfied.

### Advantageous Effects of Invention

According to one aspect of the present invention, a model training apparatus, a model training method, and a storage medium that have a small load during training a model that evaluates three-dimensional data indicating a shape of an object can be provided.

### BRIEF DESCRIPTION OF THE DRAWINGS

FIG. 1 It is a diagram illustrating an overview of a model training apparatus according to an example embodiment.

FIG. 2 It is a diagram illustrating a configuration of the model training apparatus together with a usage environment of the model training apparatus.

FIG. 3 It is a diagram for describing processing performed by a first patch generation unit of the model training apparatus.

FIG. 4 It is a diagram for describing processing performed by a second patch generation unit of the model training apparatus.

FIG. 5 It is a diagram for describing one example of a problem that may be caused by using the first patch generation unit.

FIG. 6 It is a diagram for describing one example of a problem that may be caused by using the second patch generation unit.

FIG. 7 (A) and (B) are diagrams for describing a method of solving the problem illustrated in FIG. 6, and (C) is a diagram for describing a method of solving the problem illustrated in FIG. 5.

FIG. 8 It is a diagram illustrating a hardware configuration example of the model training apparatus.

FIG. 9 It is a diagram illustrating a first example of processing performed by the first patch generation unit of the model training apparatus.

FIG. 10 It is a diagram illustrating a second example of processing performed by the first patch generation unit of the model training apparatus.

FIG. 11 It is a diagram illustrating one example of processing performed by the second patch generation unit and a training unit of the model training apparatus.

### EXAMPLE EMBODIMENT

Hereinafter, an example embodiment of the present invention will be described by using the drawings. Note that, a similar component is assigned with a similar reference sign throughout all the drawings, and description therefor will be omitted as appropriate.

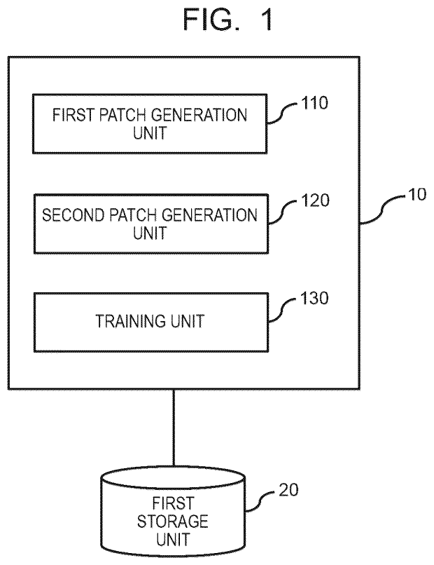

FIG. 1 is a diagram illustrating an overview of a model training apparatus 10 according to an example embodiment. The model training apparatus 10 includes a first patch generation unit 110, a second patch generation unit 120, and a training unit 130.

The first patch generation unit 110 generates, by using three-dimensional data indicating a shape of an object, at least one first patch being a subset of the three-dimensional data, and causes a first storage unit 20 to store the first patch. The second patch generation unit 120 reads out any of the first patches from the first storage unit 20, and generates at least one second patch being a subset of the first patch. The training unit 130 trains, with the second patch as training data, a model for evaluating a three-dimensional shape. Then, the second patch generation unit 120 and the training unit 130 repeat processing until a criterion is satisfied.

In the model training apparatus 10, the second patch is used for training. The second patch is a subset of the first patch. That is, data to be read out from the first storage unit 20 at each epoch are not the three-dimensional data, but the first patch being a subset of the three-dimensional data. Accordingly, a load in training a model is decreased.

Hereinafter, a detailed example of the model training apparatus 10 will be described.

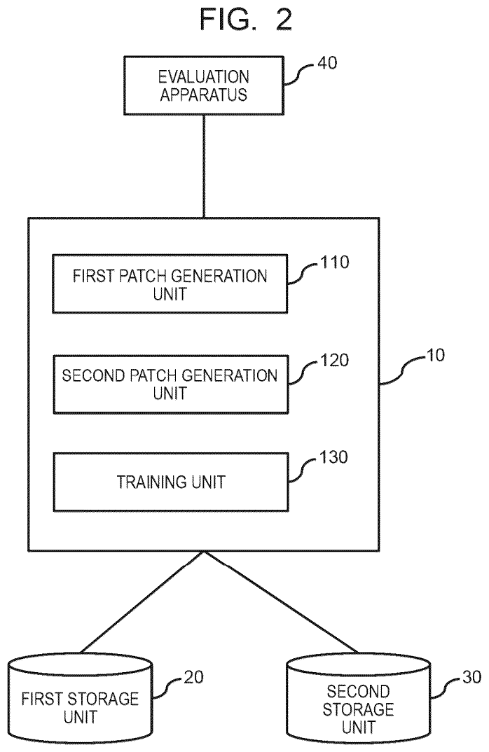

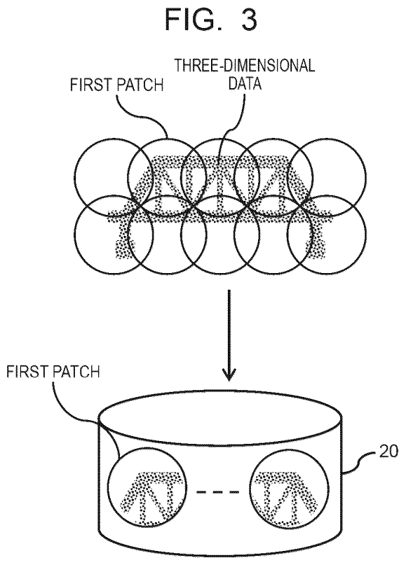

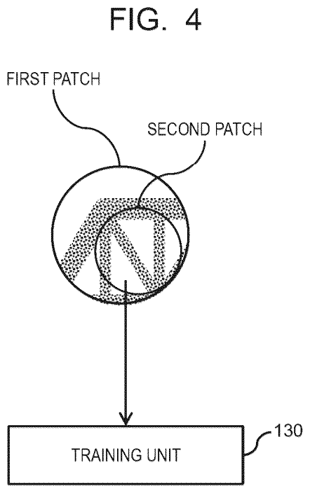

FIG. 2 is a diagram illustrating a configuration of the model training apparatus 10 together with a usage environment of the model training apparatus 10. FIG. 3 is a diagram for describing processing performed by the first patch generation unit 110 of the model training apparatus 10. FIG. 4 is a diagram for describing processing performed by the second patch generation unit 120 of the model training apparatus 10.

In an example illustrated in FIG. 2, the model training apparatus 10 is used together with the first storage unit 20, a second storage unit 30, and an evaluation apparatus 40.

The first storage unit 20 stores the first patch. When the model training apparatus 10 generates a plurality of first patches, the first storage unit 20 stores the plurality of first patches. Further, the first storage unit 20 also stores a model trained by the model training apparatus 10.

The second storage unit 30 stores at least one piece of three-dimensional data being used by the model training apparatus 10. As described above, the three-dimensional data indicate a shape of an object. The object is, for example, but not limited to, a structure such as a bridge or a building, or a part of a structure such as a bridge pier or a bridge girder. The second storage unit 30 may store three-dimensional data of each of a plurality of objects.

The three-dimensional data are, for example, point cloud data generated by using LiDAR. In this case, the three-dimensional data are a set of points having coordinate data transformable to XYZ coordinates. The coordinate data used herein may directly indicate XYZ coordinates, or may be polar coordinate data (a set of an angle of elevation, a horizontal angle, and a distance) with a sensor position as an origin. When the object is a large-scale structure such as a bridge or a building, the number of points included in point cloud data may exceed ten million.

Note that, the three-dimensional data may be data other than point cloud data. For example, the three-dimensional data may be mesh data expressing three-dimensional information as a set of vertices, edges, and faces.

Further, the three-dimensional data may include labels set by a plurality of parts in the object. For example, when the three-dimensional data are point cloud data, a label is set for each of a plurality of points composing the point cloud data. One example of the label used herein is whether the part is abnormal. However, a unit of data to which a label is assigned and a content of the label are not limited to the above-described example.

The evaluation apparatus 40 processes, by using a model trained by the model training apparatus 10, the three-dimensional data of an object to be evaluated.

Then, the model training apparatus 10 includes the first patch generation unit 110, the second patch generation unit 120, and the training unit 130, as described above. The first patch generation unit 110 among the above performs processing before a model is trained. In contrast, the second patch generation unit 120 and the training unit 130 perform processing at each epoch.

The first patch generation unit 110 reads out the three-dimensional data from the second storage unit 30, and generates at least one first patch by using the read-out three-dimensional data, as illustrated in FIG. 3. The first patch is a subset of the three-dimensional data, and indicates a shape of a part of an object. The first patch generation unit 110 preferably generates a plurality of first patches from one piece of three-dimensional data. Further, when the second storage unit 30 stores a plurality of pieces of three-dimensional data, the first patch generation unit 110 generates at least one first patch, preferably a plurality of first patches, from each of the plurality of pieces of three-dimensional data.

The amount of data for the first patch is, for example, but not limited to, 1/100 or less of the three-dimensional data used in generating the first patch. Further, when the three-dimensional data are point cloud data, the number of points included in the first patch is, for example, but not limited to, one hundred thousand or less.

The first patch generation unit 110 preferably ensures that every part of the three-dimensional data is included in at least one first patch. Herein, at least a part of the three-dimensional data may be included in a plurality of first patches.

Then, the first patch generation unit 110 causes the first storage unit 20 to store the generated first patch. Herein, when the first patch is generated from each of a plurality of pieces of the three-dimensional data, the first patch generation unit 110 preferably causes the first storage unit 20 to store the first patch in association with the three-dimensional data used in generating the first patch.

The first patch generation unit 110 may generate the first patch by using a label included in the three-dimensional data. For example, there may be a large difference between labels in the number of pieces of data having the label. In this case, the first patch generation unit 110 preferably generates the first patch in such a way as to cause no deviation in contents of training data attributable to the difference.

For example, a case will be considered in which the three-dimensional data include a plurality of parts and a label is assigned by the plurality of parts. It is assumed that a first number being the number of parts having a first label is less than a second number being the number of parts having a second label. When the number of first patches including the first label is assumed to be a first number of patches and the number of first patches including the second label is assumed to be a second number of patches, the first patch generation unit 110 sets a ratio of the first number of patches to the second number of patches higher than a ratio of the first number to the second number. By doing so, the number of pieces of training data having the first label is increased in comparison with a case of doing nothing.

As one example, a case will be considered in which a label indicates whether the part includes an abnormality. In this case, abnormal data are often less than non-abnormal data. In this case, a label indicating abnormality is equivalent to the above-described first label, and a label indicating no abnormality is equivalent to the above-described second label. The first patch generation unit 110 preferentially generates the first patch that includes data having a label indicating abnormality. In other words, the first patch generation unit 110 leaves the first patch relevant to a minority label (for example, the above-described first label) with a higher probability than the first patch relevant to a majority label (for example, the above-described second label).

As one example, an operation of the first patch generation unit 110 in semantic segmentation in which the three-dimensional data are point cloud data and the number of labels is two will be described. It is assumed that each point in the three-dimensional data is assigned with a label 0 or a label 1, the label 0 being a majority over the label 1. In this case, the first patch generation unit 110 operates in such a way as to leave the first patch including a point with the label 1 with a higher probability than the first patch not including the label 1. The first patch generation unit 110 may leave only the first patch including the label 1.

Return to FIG. 2. The second patch generation unit 120 reads out the first patch from the first storage unit 20, and generates at least one second patch by using the read-out first patch, as illustrated in FIG. 4. As described by using FIG. 1, the second patch is a subset of the first patch, and indicates a shape of a part further in a part indicated by the first patch of an object.

A method of generating the second patch performed by the second patch generation unit 120 may be any method, as long as the method is capable of generating a patch as training data. Examples of the method used herein include (1) to (3) below.

(1) The second patch generation unit 120 superposes a predetermined shape on the first patch, and generates the second patch by using a result of the superposition.

The predetermined shape is, for example, a convex figure such as a sphere, a cuboid, a cylinder, or an ellipsoid, or is a union or a set difference of a plurality of convex figures. Then, the second patch generation unit 120 determines, for example, a common part between the first patch and the predetermined shape as the second patch. Herein, a part of the first patch overlapping with the predetermined shape or an orientation of the predetermined shape may be selected randomly.

(2) The second patch generation unit 120 selects a reference point in the first patch, selects another part according to a predetermined rule from the reference point, and thereby generates the second patch.

For example, when the three-dimensional data are point cloud data, the first patch and the second patch are also point cloud data. In this case, the second patch generation unit 120 first selects a point to be a reference point from a plurality of points included in the first patch. This selection may be performed randomly. Then, the second patch generation unit 120 selects a predetermined number of points according to a predetermined rule from the reference point. Then, the second patch generation unit 120 determines the points and the reference point as a second patch.

Herein, the second patch generation unit 120 can use, for example, two methods of (2-1) and (2-2) below upon selecting a point other than a reference point.

(2-1) The second patch generation unit 120 selects a point close in distance to a reference point. Herein, the second patch generation unit 120 may select a predetermined number of points in order of proximity to the reference point. This technique is, for example, k-nearest neighbor search.
(2-2) The second patch generation unit 120 selects a point close in distance and feature to a reference point. Herein, the second patch generation unit 120 may select a reference point randomly. Then, the second patch generation unit 120 may select points that satisfy a criterion for similarity to the reference point of shape information such as a normal or a PCA feature value, and may select a predetermined number of points from among the point in order of proximity to the reference point. This technique is, for example, region growing.
(3) The second patch generation unit 120 divides the first patch into a plurality of subsets that are similar to each other in at least one of distance and shape, and thereby generates the second patch.

The second patch generation unit 120 generates the second patch from the first patch by using a segmentation technique, for example, RANSAC or cut-pursuit. RANSAC is a technique for extracting a planar part from the three-dimensional data. Further, cut-pursuit is a technique for dividing the three-dimensional data into a plurality of subsets that are similar in distance and shape, and a detailed example is disclosed in, for example, following URL<https://github.com/loicland/cut-pursuit>. Then, the subset to be the second patch is selected randomly.

The training unit 130 trains a model by using the second patch generated by the second patch generation unit 120, as illustrated in FIG. 4. The model used herein is a model for recognizing a state of a three-dimensional shape. A recognition task used in this model is, for example, but not limited to, at least one of classification, semantic segmentation, and an autoencoder. Further, a recognition model is, for example, but not limited to, PointNet++. Note that, a detailed example of PointNet++ is disclosed in, for example, following URL<https://arxiv.org/abs/1706.02413>.

In training data used by the training unit 130, an explanatory variable is the above-described second patch, and an objective variable is set, for example, by using a label included in the second patch to be the explanatory variable. For example, when a label indicates abnormality or not, the label is the explanatory variable. When the three-dimensional data, the first patch, and the second patch are point cloud data, one example of the explanatory variable is whether the second patch includes a point assigned with a label of abnormality.

The second patch generation unit 120 and the training unit 130 repeat processing until a criterion is satisfied. The criterion used herein is, for example, that the number of repetition (the number of epochs) reaches a predetermined value, that a value from a loss function of a model after training satisfies a predetermined condition, or that accuracy of a model after training satisfies a predetermined condition. However, a criterion other than the above may be used.

Note that, when the objective variable of training data is whether the second patch being the explanatory variable includes an abnormality, the model trained by the training unit 130 is a model for detecting a location of abnormality in an object, for example, a structure.

Then, the training unit 130 causes the first storage unit 20 to store the model after training. The model training apparatus 10 transmits the model stored in the first storage unit 20 to the evaluation apparatus 40 as needed. The evaluation apparatus 40 evaluates the object by using the model.

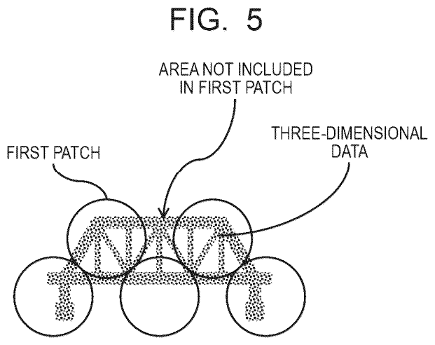

Next, a detailed example of an operation of the first patch generation unit 110 and the second patch generation unit 120 will be described by using FIGS. 5 to 7.

FIG. 5 is a diagram for describing one example of a problem that may be caused by using the first patch generation unit 110. In a case where a condition used in generating the first patch is not appropriately set, there arises a possibility that a part of the three-dimensional data may be an area that is not included in any of the first patches, as illustrated in FIG. 5.

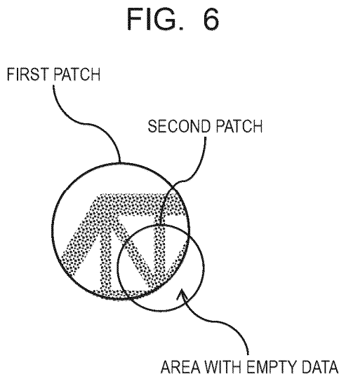

FIG. 6 is a diagram for describing one example of a problem that may be caused by using the second patch generation unit 120. In a case where a condition used in generating the second patch is not appropriately set, the second patch may have a data configuration that may not be generated in a case of directly generating a patch from the three-dimensional data, as illustrated in FIG. 6. In the example illustrated in FIG. 6, data are supposed to be present in a lower right-side area of the second patch, because a part of the object is originally present. However, in the example illustrated in the present figure, this area is out of the first patch and thus does not include data.

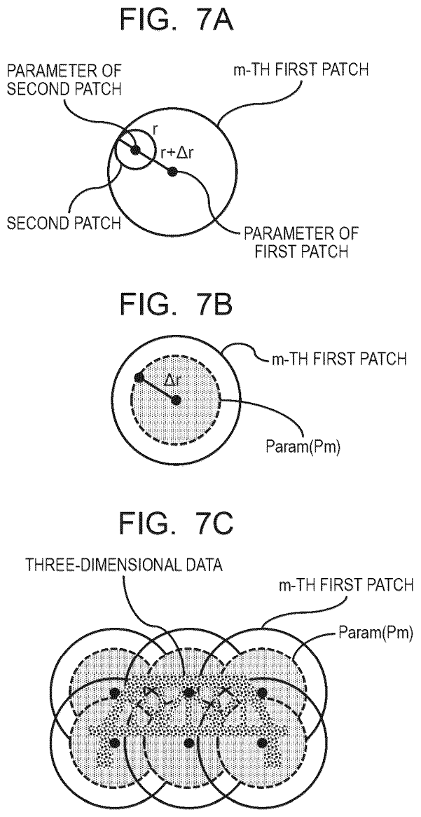

FIGS. 7(A) and 7(B) are diagrams for describing a condition for solving the problem indicated in FIG. 6. In order to solve the problem indicated in FIG. 6, all parts of the second patch need to be included in the first patch. Hereinafter, a condition necessary therefor will be described.

The first patch generation unit 110 generates the first patch randomly from the three-dimensional data, and the second patch generation unit 120 generates the second patch randomly from the first patch. At this time, the first patch generation unit 110 and the second patch generation unit 120 use a parameter for controlling randomness. For example, when the first patch and the second patch are both spheres, this parameter is a center position of the sphere. Then, as illustrated in FIG. 7(A), when the second patch has a radius of r and the first patch has a radius of r+Δr, and the center of the second patch is located in a sphere having a radius of Δr from the center of the first patch, all parts of the second patch are included in the first patch.

Generalizing this, the second patch generation unit 120 needs to, “when selecting the second patch from the m-th first patch, select a parameter from a range Param (Pm) of parameters that the second patch may take under a condition that the second patch is included in the first patch”. Herein, one example of Param (Pm) is “a sphere having a radius of Δr from the center of the first patch”. Note that, Param (Pm) may indicate a range that a parameter may take when a condition that the second patch generated from the m-th first patch can be generated also directly from the three-dimensional data is satisfied, as will be described by using FIG. 7(C).

FIG. 7(C) is a diagram for describing a condition for solving the problem indicated in

FIG. 5. As illustrated in the present figure, the first patch generation unit 110 needs to ensure that any part of the three-dimensional data is included in at least one first patch. To do so, the first patch generation unit 110 needs to generate a plurality of first patches at intervals d in such a way as to cover the entire three-dimensional data. In this case, d is (2/√3)Δr or less. Then, when the center of the second patch is located in a sphere having a radius of Δr from the center of the first patch as illustrated in FIG. 7(B), the second patch that may be generated is comparable to a patch directly generated from the three-dimensional data, including randomness or coverability.

Generalization of this is as follows.

The three-dimensional data or a subset of the three-dimensional data is denoted by X′.
A set of parameters satisfying a condition that the second patch is available as training data and includes at least a part of X′ is denoted by PX′. This PX′ is a set of such parameters “in which, in generating a patch from X, a generated patch is available as training data and includes at least a part of X′”.
A range of parameters that the second patch may take for the m-th first patch is the above-described Param (Pm). Param (Pm) indicates a range that a parameter may take when a condition that the second patch generated from the m-th first patch can be generated also directly from the three-dimensional data is satisfied.

In this case, the first patch generation unit 110 generates N first patches in such a way as to satisfy

$$Param ( P 1 ) ⋃ Param ( P 2 ) ⋃ … ⋃ Param ( PN ) ⊇ {PX}^{′} \qquad ( 1 )$$

In other words, upon computing a union of Param (Pm) from m=1 to N, PX′ is included in the union. The above expression (1) indicates that “all patches generated from X based on PX′ are covered by a union of all patches generated from X based on each Param”.

Note that, in selecting a parameter, that is, a sphere center from Param (Pm) in the example illustrated in FIG. 7(B), it is preferable to select the parameter from a cube inscribed in a sphere as Param (Pm). By doing so, overlap between neighboring Param (Pm) is eliminated, thus making ease of parameter selection uniform over the entire three-dimensional data.

Generalization of this is as follows. When it is assumed that the second patch generation unit 120 selects, in generating the second patch from the m-th first patch, a parameter of the second patch from Param (Pm)′ being a subset of Param (Pm), it is preferable to satisfy

$${Param ( P 1 )}^{′} ⋂ {Param ( P 2 )}^{′} ⋂ … {Param ( PN )}^{′} = empty set$$

In other words, upon computing an intersection set of Param (Pm)′ from m=1 to N, this intersection set is an empty set. By doing so, the second patch generation unit 120 is capable of uniformly selecting a parameter of the second patch from PX′.

The contents described by using each figure in FIG. 7 are logically described as follows.

The second patch generated by the second patch generation unit 120 based on any first patch P and any parameter p is denoted by Q(p, P).

A set of parameters p in which Q(p, P) and Q(p, X) are identical for any first patch P is denoted by Param (P). In other words, as long as the second patch generation unit 120 generates the second patch based on the parameter p included in Param (P), the peculiar second patch as illustrated in FIG. 6 is not generated.

A set of parameters p satisfying a condition that Q(p, X) is available as training data and includes even a part of X′ is written as PX′. In other words, there is an equivalence between the parameter p being included in PX′ and Q(p, X) being “the second patch that includes even a part of X′”.

The first patch generation unit 110 generates at least N pieces of the first patches P1, P2, . . . , PN. At this time, the first patch generation unit 110 generates the N pieces of the first patches in such a way that the above equation (1), that is,

$$Param ( P 1 ) ⋃ Param ( P 2 ) ⋃ … ⋃ Param ( PN ) ⊇ {PX}^{′}$$

holds.

Furthermore, the second patch generation unit 120 selects, based on the first patch P, at least one parameter p included in Param (P), and generates at least one second patch Q(p, P).

At this time, the second patch to be generated may encompass “the second patch that includes even a part of X′”. This is because the second patch Q(p, P) is always identical to Q(p, X) from the definition of Param (P), and furthermore, the parameter p to be selected may encompass PX′ from the above expression (1).

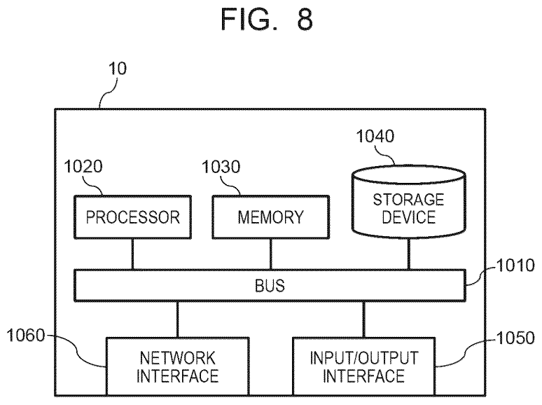

FIG. 8 is a diagram illustrating a hardware configuration example of the model training apparatus 10. The model training apparatus 10 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit and receive data to and from one another. However, a method of connecting the processor 1020 and the like with one another is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a removable medium such as a memory card, a read only memory (ROM), or the like. A storage medium of the storage device 1040 stores program modules for achieving functions (for example, the first patch generation unit 110, the second patch generation unit 120, and the training unit 130) of the model training apparatus 10. Each of the program modules is read in to the memory 1030 and executed by the processor 1020, and thereby each function relevant to the program module is achieved. Further, the storage device 1040 may function as at least one of the first storage unit 20 and the second storage unit 30.

The input/output interface 1050 is an interface for connecting the model training apparatus 10 to various kinds of input/output equipment. For example, the model training apparatus 10 communicates with the first storage unit 20 and the second storage unit 30 via the input/output interface 1050.

The network interface 1060 is an interface for connecting the model training apparatus 10 to a network. The network is, for example, a local area network (LAN) or a wide area network (WAN). A method by which the network interface 1060 connects to a network may be wireless communication, or may be wired communication. The model training apparatus 10 may communicate with the evaluation apparatus 40 via the network interface 1060.

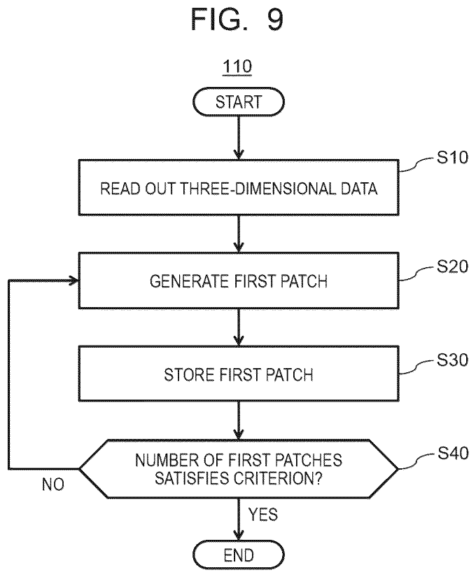

FIG. 9 is a diagram illustrating a first example of processing performed by the first patch generation unit 110 of the model training apparatus 10. The first patch generation unit 110 generates a first patch in advance before the second patch generation unit 120 and the training unit 130 perform processing.

Specifically, the first patch generation unit 110 reads out three-dimensional data to be processed from the second storage unit 30 (Step S10). Next, the first patch generation unit 110 generates a first patch from the read-out three-dimensional data (Step S20), and causes the first storage unit 20 to store the generated first patch (Step S30). The first patch generation unit 110 repeats Steps S20 and S30 until the number of first patches stored by the first storage unit 20 satisfies a criterion (Step S40).

Note that, when the second storage unit 30 stores a plurality of pieces of three-dimensional data, the first patch generation unit 110 performs the processing illustrated in FIG. 9 on each of the plurality of pieces of three-dimensional data.

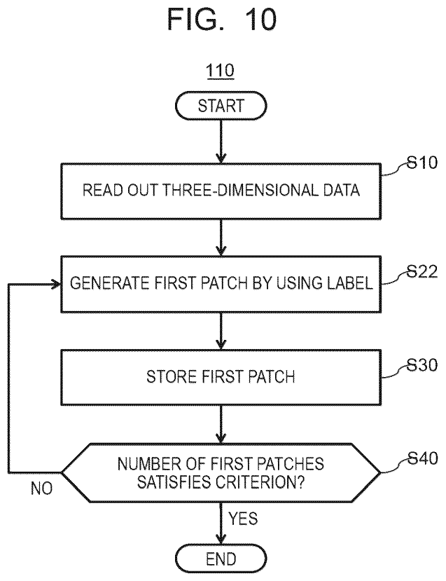

FIG. 10 is a diagram illustrating a second example of processing performed by the first patch generation unit 110 of the model training apparatus 10. In the example illustrated in the present figure, the first patch generation unit 110 is similar to the example illustrated in FIG. 9, excluding a point of generating a first patch by using a label included in three-dimensional data (Step S22). A specific example of how to use the label is as described by using FIG. 2.

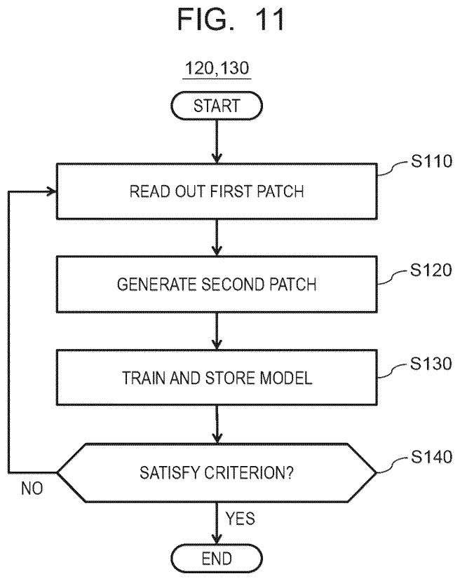

FIG. 11 is a diagram illustrating one example of processing performed by the second patch generation unit 120 and the training unit 130 of the model training apparatus 10. First, the second patch generation unit 120 reads out a first patch from the first storage unit 20. Herein, when the first storage unit 20 stores a plurality of first patches, the second patch generation unit 120 selects one first patch from the plurality of first patches, and reads out the selected first patch. At this time, the second patch generation unit 120 selects a first patch randomly (Step S110).

Next, the second patch generation unit 120 generates at least one second patch by using the read-out first patch (Step S120). Next, the training unit 130 trains a model by using the second patch generated by the second patch generation unit 120, and causes the first storage unit 20 to store the model after training (Step S130).

The second patch generation unit 120 and the training unit 130 repeat the processing indicated in Steps S110 to S130 until a criterion is satisfied (Step S140).

As described above, according to the present example embodiment, the model training apparatus 10 includes the first patch generation unit 110. The first patch generation unit 110 generates a first patch being a subset of three-dimensional data, and causes the first storage unit 20 to store the first patch. Then, the second patch generation unit 120 generates, by using the first patch stored in the first storage unit 20, a second patch to be training data. Since the first patch is a subset of two-dimensional data, a load on the model training apparatus 10 is decreased in comparison with a case of generating a patch to be training data directly from three-dimensional data. Accordingly, a load on the model training apparatus 10 in training a model that evaluates three-dimensional data indicating a shape of an object is decreased.

While the example embodiment of the present invention has been described with reference to the drawings, the example embodiment is illustrative of the present invention, and various configurations other than the above can be employed.

Further, while a plurality of processes (pieces of processing) are described in order in a plurality of flowcharts used in the above description, execution order of processes executed in each example embodiment is not limited to the described order. The order of the illustrated processes can be changed in each example embodiment, as long as the change does not detract from contents. Further, the above example embodiments can be combined, as long as contents do not contradict each other.

The whole or part of the above-described example embodiment can be described as, but not limited to, the following supplementary notes.

1. A model training apparatus including:
a first patch generation unit that generates, by using three-dimensional data indicating a shape of an object, at least one first patch being a subset of the three-dimensional data, and causes a storage unit to store the first patch;
a second patch generation unit that reads out any of the first patches from the storage unit, and generates at least one second patch being a subset of the first patch; and
a training unit that trains, with the second patch as training data, a model for evaluating a three-dimensional shape, wherein
the second patch generation unit and the training unit repeat processing until a criterion is satisfied.
   2. The model training apparatus according to the above-described 1, wherein
the first patch generation unit generates N pieces of the first patches by using a parameter for controlling randomness of a patch,
the second patch generation unit generates the second patch by using the parameter, and
when the three-dimensional data or a subset of the three-dimensional data is denoted by X′,
a set of the parameters satisfying a condition that the second patch is available as training data and includes at least a part of the X′ is denoted by PX′, and
a range that the parameter may take for the m-th first patch when a condition that the second patch generated from the first patch can be generated also directly from the three-dimensional data is satisfied is denoted by Param (Pm),
the first patch generation unit ensures that, upon computing a union of the Param (Pm) from m=1 to N, the PX′ is included in the union.
   3. The model training apparatus according to the above-described 2, wherein
the second patch generation unit selects the parameter from the Param (Pm).
   4. The model training apparatus according to the above-described 2 or 3, wherein
the second patch generation unit selects, when generating the second patch from the m-th first patch, a parameter of the second patch from Param (Pm)′ being a subset of the Param (Pm), and
upon computing an intersection set of the Param (Pm)′ from m=1 to N, the intersection set is an empty set.
   5. The model training apparatus according to any one of the above-described 1 to 4, wherein
the three-dimensional data include labels set by a plurality of parts in the object, and
the first patch generation unit generates a plurality of the first patches by using the labels.
   6. The model training apparatus according to the above-described 5, wherein
a first number being a number of the parts having the first label is less than a second number being a number of the parts having the second label, and
when a number of the first patches including the first label is denoted by a first number of patches and a number of the first patches including the second label is denoted by a second number of patches,
the first patch generation unit sets a ratio of the first number of patches to the second number of patches higher than a ratio of the first number to the second number.
   7. The model training apparatus according to any one of the above-described 1 to 6, wherein
the second patch generation unit superposes a predetermined shape on the first patch, and generates the second patch by using a result of the superposition.
   8. The model training apparatus according to any one of the above-described 1 to 6, wherein
the second patch generation unit generates the second patch by selecting a reference point in the first patch, and selecting another part from the first patch according to a predetermined rule from the reference point.
   9. The model training apparatus according to any one of the above-described 1 to 6, wherein
the second patch generation unit generates the second patch by dividing the first patch into a plurality of subsets that are similar to each other in at least one of distance and shape.
   10. The model training apparatus according to any one of the above-described 1 to 9, wherein
the training data includes information indicating whether the second patch includes a location of abnormality generated in the object, and
the model is a model for detecting a location of abnormality in an object.
   11. A model training method including,
by a computer:
generating, by using three-dimensional data indicating a shape of an object, at least one first patch being a subset of the three-dimensional data, and causing a storage unit to store the first patch;
reading out any of the first patches from the storage unit, and generating at least one second patch being a subset of the first patch; and
training, with the second patch as training data, a model for evaluating a three-dimensional shape, wherein
the generating the second patch and the training the model are repeated until a criterion is satisfied.
   12. The model training method according to the above-described 11, wherein
the computer generates N pieces of the first patches by using a parameter for controlling randomness of a patch,
the computer generates the second patch by using the parameter, and
when the three-dimensional data or a subset of the three-dimensional data is denoted by X′,
a set of the parameters satisfying a condition that the second patch is available as training data and includes at least a part of the X′ is denoted by PX′, and
a range that the parameter may take for the m-th first patch when a condition that the second patch generated from the first patch can be generated also directly from the three-dimensional data is satisfied is denoted by Param (Pm),
the computer ensures that, upon computing a union of the Param (Pm) from m=1 to N, the PX′ is included in the union.
   13. The model training method according to the above-described 12, wherein
the computer selects the parameter from the Param (Pm).
   14. The model training method according to the above-described 12 or 13, wherein
the computer selects, when generating the second patch from the m-th first patch, a parameter of the second patch from Param (Pm)′ being a subset of the Param (Pm), and
upon computing an intersection set of the Param (Pm)′ from m=1 to N, the intersection set is an empty set.
   15. The model training method according to any one of the above-described 11 to 14, wherein
the three-dimensional data include labels set by a plurality of parts in the object, and
the computer generates a plurality of the first patches by using the labels.
   16. The model training method according to the above-described 15, wherein
a first number being a number of the parts having the first label is less than a second number being a number of the parts having the second label, and
when a number of the first patches including the first label is denoted by a first number of patches and a number of the first patches including the second label is denoted by a second number of patches,
the computer sets a ratio of the first number of patches to the second number of patches higher than a ratio of the first number to the second number.
   17. The model training method according to any one of the above-described 11 to 16, wherein
the computer superposes a predetermined shape on the first patch, and generates the second patch by using a result of the superposition.
   18. The model training method according to any one of the above-described 11 to 16, wherein
the computer generates the second patch by selecting a reference point in the first patch, and selecting another part from the first patch according to a predetermined rule from the reference point.
   19. The model training method according to any one of the above-described 11 to 16, wherein
the computer generates the second patch by dividing the first patch into a plurality of subsets that are similar to each other in at least one of distance and shape.
   20. The model training method according to any one of the above-described 11 to 19, wherein
the training data includes information indicating whether the second patch includes a location of abnormality generated in the object, and
the model is a model for detecting a location of abnormality in an object.
   31. A computer-readable storage medium that stores a program causing a computer to have:
a first patch generation function of generating, by using three-dimensional data indicating a shape of an object, at least one first patch being a subset of the three-dimensional data, and causing a storage unit to store the first patch;
a second patch generation function of reading out any of the first patches from the storage unit, and generating at least one second patch being a subset of the first patch; and
a training function of training, with the second patch as training data, a model for evaluating a three-dimensional shape, wherein
the second patch generation function and the training function repeat processing until a criterion is satisfied.
   32. The storage medium according to the above-described 31, wherein
the first patch generation function generates N pieces of the first patches by using a parameter for controlling randomness of a patch,
the second patch generation function generates the second patch by using the parameter, and
when the three-dimensional data or a subset of the three-dimensional data is denoted by X′,
a set of the parameters satisfying a condition that the second patch is available as training data and includes at least a part of the X′ is denoted by PX′, and
a range that the parameter may take for the m-th first patch when a condition that the second patch generated from the first patch can be generated also directly from the three-dimensional data is satisfied is denoted by Param (Pm),
the first patch generation function ensures that, upon computing a union of the Param (Pm) from m=1 to N, the PX′ is included in the union.
   33. The storage medium according to the above-described 32, wherein
the second patch generation function selects the parameter from the Param (Pm).
   34. The storage medium according to the above-described 32 or 33, wherein
the second patch generation function selects, in generating the second patch from the m-th first patch, a parameter of the second patch from Param (Pm)′ being a subset of the Param (Pm), and
upon computing an intersection set of the Param (Pm)′ from m=1 to N, the intersection set is an empty set.
   35. The storage medium according to any one of the above-described 31 to 34, wherein
the three-dimensional data include labels set by a plurality of parts in the object, and
the first patch generation function generates a plurality of the first patches by using the labels.
   36. The storage medium according to the above-described 35, wherein
a first number being a number of the parts having the first label is less than a second number being a number of the parts having the second label, and
when a number of the first patches including the first label is denoted by a first number of patches and a number of the first patches including the second label is denoted by a second number of patches,
the first patch generation function sets a ratio of the first number of patches to the second number of patches higher than a ratio of the first number to the second number.
   37. The storage medium according to any one of the above-described 31 to 36, wherein
the second patch generation function superposes a predetermined shape on the first patch, and generates the second patch by using a result of the superposition.
   38. The storage medium according to any one of the above-described 31 to 36, wherein
the second patch generation function generates the second patch by selecting a reference point in the first patch, and selecting another part from the first patch according to a predetermined rule from the reference point.
   39. The storage medium according to any one of the above-described 31 to 36, wherein
the second patch generation function generates the second patch by dividing the first patch into a plurality of subsets that are similar to each other in at least one of distance and shape.
   40. The storage medium according to any one of the above-described 31 to 39, wherein
the training data includes information indicating whether the second patch includes a location of abnormality generated in the object, and
the model is a model for detecting a location of abnormality in an object.
   41. The program according to any one of the above-described 31 to 40.

### Reference Signs List

10 Model training apparatus

110 First patch generation unit

120 Second patch generation unit

130 Training unit

20 First storage unit

30 Second storage unit

40 Evaluation apparatus

What is claimed is:

1. A model training apparatus comprising:
at least one memory configured to store instructions; and
at least one processor configured to execute the instructions to:
generate, by using three-dimensional data indicating a shape of an object, at least one first patch being a subset of the three-dimensional data, and cause a storage unit to store the first patch;
read out any of the first patches from the storage unit, and generates at least one second patch being a subset of the first patch;
train, with the second patch as training data, a model for evaluating a three-dimensional shape; and
repeat processes of generating the second patch and training the model until a criterion is satisfied.

2. The model training apparatus according to claim 1, wherein
the at least one processor is configured to execute the instructions to:
generate N pieces of the first patches by using a parameter for controlling randomness of a patch;
generate the second patch by using the parameter; and
when the three-dimensional data or a subset of the three-dimensional data is denoted by X′,
a set of the parameters satisfying a condition that the second patch is available as training data and includes at least a part of the X′ is denoted by PX′, and
a range that the parameter may take for the m-th first patch when a condition that the second patch generated from the first patch can be generated also directly from the three-dimensional data is satisfied is denoted by Param (Pm),
ensure that, upon computing a union of the Param (Pm) from m=1 to N, the PX′ is included in the union.

3. The model training apparatus according to claim 2, wherein
the at least one processor is configured to execute the instructions to select the parameter from the Param (Pm).

4. The model training apparatus according to claim 2, wherein
the at least one processor is configured to execute the instructions to select, when generating the second patch from the m-th first patch, a parameter of the second patch from Param (Pm)′ being a subset of the Param (Pm), and
upon computing an intersection set of the Param (Pm)′ from m=1 to N, the intersection set is an empty set.

5. The model training apparatus according to claim 1, wherein
the three-dimensional data include labels set by a plurality of parts in the object, and
the at least one processor is configured to execute the instructions to generate a plurality of the first patches by using the labels.

6. The model training apparatus according to claim 5, wherein
a first number being a number of the parts having the first label is less than a second number being a number of the parts having the second label, and
when a number of the first patches including the first label is denoted by a first number of patches and a number of the first patches including the second label is denoted by a second number of patches,
the at least one processor is configured to execute the instructions to set a ratio of the first number of patches to the second number of patches higher than a ratio of the first number to the second number.

7. The model training apparatus according to claim 1, wherein
the at least one processor is configured to execute the instructions to superpose a predetermined shape on the first patch, and generate the second patch by using a result of the superposition.

8. The model training apparatus according to claim 1, wherein
the at least one processor is configured to execute the instructions to generate the second patch by selecting a reference point in the first patch, and selecting another part from the first patch according to a predetermined rule from the reference point.

9. The model training apparatus according to claim 1, wherein
the at least one processor is configured to execute the instructions to generate the second patch by dividing the first patch into a plurality of subsets that are similar to each other in at least one of distance and shape.

10. The model training apparatus according to claim 1, wherein
the training data includes information indicating whether the second patch includes a location of abnormality generated in the object, and
the model is a model for detecting a location of abnormality in an object.

11. A model training method comprising,
by a computer:
generating, by using three-dimensional data indicating a shape of an object, at least one first patch being a subset of the three-dimensional data, and causing a storage unit to store the first patch;
reading out any of the first patches from the storage unit, and generating at least one second patch being a subset of the first patch; and
training, with the second patch as training data, a model for evaluating a three-dimensional shape, wherein
the generating the second patch and the training the model are repeated until a criterion is satisfied.

12. A non-transitory computer-readable storage medium that stores a program causing a computer to execute:
generating, by using three-dimensional data indicating a shape of an object, at least one first patch being a subset of the three-dimensional data, and causing a storage unit to store the first patch;
reading out any of the first patches from the storage unit, and generating at least one second patch being a subset of the first patch; and
training, with the second patch as training data, a model for evaluating a three-dimensional shape; and
repeating processes of generating the second patch and training the model until a criterion is satisfied.
